(19) United States
(12) Patent Application Publication
(10) Pub. No.: US 2018/0049027 A1
(43) Pub. Date: Feb. 15, 2018

(54) ADDING AUTHENTICATABLE SIGNATURES TO ACKNOWLEDGEMENTS

(71) Applicant: QUALCOMM Incorporated, San Diego, CA (US)

(72) Inventors: Santosh Paul Abraham, San Diego, CA (US); George Cherian, San Diego, CA (US); Alireza Raissinia, Monte Sereno, CA (US); Abhishek Pramod Patil, San Diego, CA (US); Naveen Kumar Kakani, Coppell, TX (US); James Simon Cho, Mountain View, CA (US); Jouni Malinen, Tu'usula (FI)

(21) Appl. No.: 15/673,281

(22) Filed: Aug. 9, 2017

Related U.S. Application Data
(60) Provisional application No. 62/373,897, filed on Aug. 11, 2016.
(60) Provisional application No. 62/404,736, filed on Oct. 5, 2016.

(51) Int. Cl. H04W 12/06; H04L 9/32; G06F 11/10; H04L 1/18; H03M 13/29; H04W 12/04; H04L 29/06

(52) U.S. Cl. CPC H04W 12/06; H04W 12/04; H04L 9/3247; H04L 63/083; H04L 63/06; H04L 63/0428; H04L 1/1812; H03M 13/29; G06F 11/1004

(57) ABSTRACT

A method for wireless communication may include receiving a communication and determining an acknowledgement signature for an acknowledgment in response to the communication. The acknowledgment signature may allow for authentication with the transmitting wireless device. The acknowledgment signature may be based on a key shared with the wireless device. An acknowledgement frame (e.g., acknowledging reception of the communication) may then be sent to the transmitting wireless device. The content of the acknowledgement may be based on the acknowledgement signature. For example, the signature may be included in a frame control, duration, or address field. Determining the acknowledgement signature may include determining a unique signature based on information from the received communication (e.g., a cyclic redundancy check (CRC)), the shared key, and/or a hash function. In some cases, the acknowledgement frame may include an encryption header, and a message integrity check may be included as the acknowledgement signature.

### CROSS REFERENCES

The present Application for Patent claims priority to U.S. Provisional Patent Application No. 62/373,897 by Abraham, et al., entitled “ADDING AUTHENTICATABLE SIGNATURES TO ACKNOWLEDGEMENTS,” filed Aug. 11, 2016, assigned to the assignee hereof, and Application No. 62/404,736, entitled “SECURING FINE TIMING MEASUREMENT MESSAGE EXCHANGE AND ACK MESSAGE EXCHANGE,” filed Oct. 5, 2016, assigned to the assignee hereof, and each of which is hereby expressly incorporated by reference herein in its entirety.

### BACKGROUND

The following relates generally to wireless communication, and more specifically to adding authenticatable signatures to acknowledgements (ACKs).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via downlink and uplink communications. The downlink (or forward link) may refer to the communication link from the AP to the STA, and the uplink (or reverse link) may refer to the communication link from the STA to the AP.

Some wireless communications systems may use mechanisms for error-correcting and error-control of transmissions. Such mechanisms may include associating a transmission with an acknowledgement of reception. Other applications, such as ranging, may incorporate timing of transmission and acknowledgment reception between two devices. Acknowledgments in such procedures may include a fixed packet with a destination address, frame check sequence, etc. and may not identify that the sender (e.g., the STA sending the acknowledgment) is the intended recipient of the original transmission. Therefore, the recipient of the acknowledgment may be unable to confirm that the acknowledgment is indeed from a particular STA. Such ambiguity with regard to the source (e.g., STA) associated with the acknowledgment may result in degraded system performance (e.g., inaccurate ranging estimates, malicious attacks by an intercepting STA, etc.).

### SUMMARY

The described techniques relate to improved methods, systems, devices, or apparatuses that support adding authenticatable signatures to acknowledgments. A method for wireless communication may include receiving a communication and determining an acknowledgement signature for an acknowledgment in response to the communication. The acknowledgment signature may allow for authentication with the transmitting wireless device. The acknowledgment signature may be based on a key shared with the wireless device. An acknowledgement frame (e.g., acknowledging reception of the communication) may then be sent to the transmitting wireless device. The content of the acknowledgement may be based on the acknowledgement signature. For example, the signature may be included in a frame control, duration, or address field. Determining the acknowledgement signature may include determining a unique signature based on information from the received communication (e.g., a cyclic redundancy check (CRC)), the shared key, and/or a hash function. In some cases, the acknowledgement frame may include an encryption header, and a message integrity check may be included as the acknowledgement signature. The authenticated acknowledgment may be used, for example, for ranging determinations.

A method of wireless communication is described. The method may include receiving a communication from a wireless device, determining an acknowledgement signature for authentication with the wireless device, the acknowledgement signature being based at least in part on a key shared with the wireless device, and transmitting a frame comprising an acknowledgement for the communication to the wireless device, wherein content of the frame is based at least in part on the acknowledgement signature.

An apparatus for wireless communication is described. The apparatus may include means for receiving a communication from a wireless device, means for determining an acknowledgement signature for authentication with the wireless device, the acknowledgement signature being based at least in part on a key shared with the wireless device, and means for transmitting a frame comprising an acknowledgement for the communication to the wireless device, wherein content of the frame is based at least in part on the acknowledgement signature.

Another apparatus for wireless communication is described. The apparatus may include a processor, memory in electronic communication with the processor, and instructions stored in the memory. The instructions may be operable to cause the processor to receive a communication from a wireless device, determine an acknowledgement signature for authentication with the wireless device, the acknowledgement signature being based at least in part on a key shared with the wireless device, and transmit a frame comprising an acknowledgement for the communication to the wireless device, wherein content of the frame is based at least in part on the acknowledgement signature.

A non-transitory computer readable medium for wireless communication is described. The non-transitory computer-readable medium may include instructions operable to cause a processor to receive a communication from a wireless device, determine an acknowledgement signature for authentication with the wireless device, the acknowledgement signature being based at least in part on a key shared with the wireless device, and transmit a frame comprising an acknowledgement for the communication to the wireless device, wherein content of the frame is based at least in part on the acknowledgement signature.

Some examples of the method, apparatus, and non-transitory computer-readable medium described above may further include processes, features, means, or instructions for determining that the acknowledgement may be to be used by the wireless device for range finding. Some examples of the method, apparatus, and non-transitory computer-readable medium described above may further include processes, features, means, or instructions for including the acknowledgement signature in the frame based at least in part on the determination.

In some examples of the method, apparatus, and non-transitory computer-readable medium described above, determining the acknowledgement signature comprises: determining a unique signature based at least in part on information from the received communication, the key shared with the wireless device, and a hash function.

In some examples of the method, apparatus, and non-transitory computer-readable medium described above, the information from the received communication includes a CRC.

Some examples of the method, apparatus, and non-transitory computer-readable medium described above may further include processes, features, means, or instructions for determining a scrambler seed based at least in part on the acknowledgement signature. Some examples of the method, apparatus, and non-transitory computer-readable medium described above may further include processes, features, means, or instructions for applying the scrambler seed to the frame.

Some examples of the method, apparatus, and non-transitory computer-readable medium described above may further include processes, features, means, or instructions for including the acknowledgement signature in a scrambler seed field of the frame, a frame control portion of the frame, a duration field of the frame, an address field of the frame, or a CRC field of the frame.

In some examples of the method, apparatus, and non-transitory computer-readable medium described above, the acknowledgement signature may be provided via seven bits of the scrambler seed field. In some examples of the method, apparatus, and non-transitory computer-readable medium described above, the frame control portion of the frame includes sixteen bits, and wherein the acknowledgement signature may be provided via the least significant eight bits of the sixteen bits of the frame control field.

Some examples of the method, apparatus, and non-transitory computer-readable medium described above may further include processes, features, means, or instructions for setting a most significant bit (MSB) of the duration field to one. Some examples of the method, apparatus, and non-transitory computer-readable medium described above may further include processes, features, means, or instructions for setting the MSB of the duration field to one indicates that the duration field includes the acknowledgment signature, and wherein the acknowledgment signature may be provided via at least one or more of a remaining set of bits of the duration field. In some examples of the method, apparatus, and non-transitory computer-readable medium described above, the address field of the frame comprises a receive address field.

Some examples of the method, apparatus, and non-transitory computer-readable medium described above may further include processes, features, means, or instructions for determining a CRC for the acknowledgement based at least in part on the acknowledgement signature. Some examples of the method, apparatus, and non-transitory computer-readable medium described above may further include processes, features, means, or instructions for including the CRC in the frame.

In some examples of the method, apparatus, and non-transitory computer-readable medium described above, transmitting the frame comprising the acknowledgement further comprises: concatenating the acknowledgment signature with at least one of a scrambler seed field, a frame control field, a duration field, or a receive address field. Some examples of the method, apparatus, and non-transitory computer-readable medium described above may further include processes, features, means, or instructions for calculating CRC information based on the concatenation. Some examples of the method, apparatus, and non-transitory computer-readable medium described above may further include processes, features, means, or instructions for inserting the CRC information into the CRC field.

Some examples of the method, apparatus, and non-transitory computer-readable medium described above may further include processes, features, means, or instructions for including an encryption header within the frame. Some examples of the method, apparatus, and non-transitory computer-readable medium described above may further include processes, features, means, or instructions for determining a message integrity check (MIC) for the acknowledgement based at least in part on the encryption header, wherein the MIC may be the acknowledgement signature. In some examples of the method, apparatus, and non-transitory computer-readable medium described above, the acknowledgement comprises a block acknowledgement.

Some examples of the method, apparatus, and non-transitory computer-readable medium described above may further include processes, features, means, or instructions for including an encryption header, a block acknowledgement control field and a block acknowledgement information field within the frame. Some examples of the method, apparatus, and non-transitory computer-readable medium described above may further include processes, features, means, or instructions for determining a message integrity check (MIC) for the acknowledgement based at least in part on the encryption header without encrypting the block acknowledgement control field and the block acknowledgement information field, wherein the MIC may be the acknowledgement signature.

Some examples of the method, apparatus, and non-transitory computer-readable medium described above may further include processes, features, means, or instructions for including a control wrapper in the frame such that the acknowledgement may be wrapped between an encryption header and a message integrity check (MIC), wherein the MIC may be the acknowledgement signature.

In some examples of the method, apparatus, and non-transitory computer-readable medium described above, the acknowledgement signature may be determined based at least in part on a timing synchronization function associated with the frame, a sequence number included in the frame, or one or more fields in the frame. In some examples of the method, apparatus, and non-transitory computer-readable medium described above, the frame may be a fine timing measurement (FTM) response or a first FTM frame.

A method of wireless communication is described. The method may include transmitting a communication to a wireless device, receiving a frame comprising an acknowledgement for the communication from the wireless device, identifying an acknowledgement signature from content of the frame, the acknowledgement signature being based at least in part on a key shared with the wireless device, and authenticating the wireless device based at least in part on the acknowledgement signature.

An apparatus for wireless communication is described. The apparatus may include means for transmitting a communication to a wireless device, means for receiving a frame comprising an acknowledgement for the communication from the wireless device, means for identifying an acknowledgement signature from content of the frame, the acknowledgement signature being based at least in part on a key shared with the wireless device, and means for authenticating the wireless device based at least in part on the acknowledgement signature.

Another apparatus for wireless communication is described. The apparatus may include a processor, memory in electronic communication with the processor, and instructions stored in the memory. The instructions may be operable to cause the processor to transmit a communication to a wireless device, receive a frame comprising an acknowledgement for the communication from the wireless device, identify an acknowledgement signature from content of the frame, the acknowledgement signature being based at least in part on a key shared with the wireless device, and authenticate the wireless device based at least in part on the acknowledgement signature.

A non-transitory computer readable medium for wireless communication is described. The non-transitory computer-readable medium may include instructions operable to cause a processor to transmit a communication to a wireless device, receive a frame comprising an acknowledgement for the communication from the wireless device, identify an acknowledgement signature from content of the frame, the acknowledgement signature being based at least in part on a key shared with the wireless device, and authenticate the wireless device based at least in part on the acknowledgement signature.

Some examples of the method, apparatus, and non-transitory computer-readable medium described above may further include processes, features, means, or instructions for determining a ranging estimate to the wireless device based at least in part on the acknowledgement.

In some examples of the method, apparatus, and non-transitory computer-readable medium described above, identifying the acknowledgement signature comprises: identifying a unique signature of the wireless device based at least in part on information from the transmitted communication, the key shared with the wireless device, and a hash function.

In some examples of the method, apparatus, and non-transitory computer-readable medium described above, identifying the unique signature of the wireless device further comprises: computing a stored acknowledgment signature based on a frame and the key shared with the wireless device. Some examples of the method, apparatus, and non-transitory computer-readable medium described above may further include processes, features, means, or instructions for comparing the stored acknowledgment signature with the received acknowledgement signature. Some examples of the method, apparatus, and non-transitory computer-readable medium described above may further include processes, features, means, or instructions for determining that the received frame may be from the wireless device if the stored acknowledgement signature may be equal to the received acknowledgement signature.

In some examples of the method, apparatus, and non-transitory computer-readable medium described above, the information from the transmitted communication includes a CRC. In some examples of the method, apparatus, and non-transitory computer-readable medium described above, identifying the acknowledgement signature comprises: descrambling the frame using a scrambler seed which may be based at least in part on the acknowledgement signature.

In some examples of the method, apparatus, and non-transitory computer-readable medium described above, identifying the acknowledgement signature comprises: identifying the acknowledgement signature from a frame control portion of the frame, a duration field of the frame, an address field of the frame, a CRC of the frame, or a MIC of the frame.

In some examples of the method, apparatus, and non-transitory computer-readable medium described above, the acknowledgement signature may be determined based at least in part on a timing synchronization function associated with the frame, a sequence number included in the frame, or one or more fields in the frame. In some examples of the method, apparatus, and non-transitory computer-readable medium described above, the frame may be a FTM response or a first FTM frame.

### BRIEF DESCRIPTION OF THE DRAWINGS

FIG. 1 illustrates an example of a system for wireless communication that supports adding authenticatable signatures to acknowledgements (ACKs) in accordance with aspects of the present disclosure.

FIG. 2 illustrates an example of a wireless communications system that supports adding authenticatable signatures to ACKs in accordance with aspects of the present disclosure.

FIG. 3 illustrates an example of an ACK frame that supports adding authenticatable signatures to ACKs in accordance with aspects of the present disclosure.

FIG. 4 illustrates an example of a frame control field that supports adding authenticatable signatures to ACKs in accordance with aspects of the present disclosure.

FIG. 5 illustrates an example of an ACK frame that supports adding authenticatable signatures to ACKs in accordance with aspects of the present disclosure.

FIG. 6 illustrates an example of an ACK frame that supports adding authenticatable signatures to ACKs in accordance with aspects of the present disclosure.

FIG. 7 illustrates an example of a block ACK that supports adding authenticatable signatures to ACKs in accordance with aspects of the present disclosure.

FIG. 8 illustrates an example of a process flow that supports adding authenticatable signatures to ACKs in accordance with aspects of the present disclosure.

FIGS. 9 through 11 show block diagrams of a device that supports adding authenticatable signatures to ACKs in accordance with aspects of the present disclosure.

FIG. 12 illustrates a block diagram of a system including a station (STA) that supports adding authenticatable signatures to ACKs in accordance with aspects of the present disclosure.

FIGS. 13 through 15 show block diagrams of a device that supports adding authenticatable signatures to ACKs in accordance with aspects of the present disclosure.

FIG. 16 illustrates a block diagram of a system including an access point (AP) that supports adding authenticatable signatures to ACKs in accordance with aspects of the present disclosure.

FIGS. 17 through 19 illustrate methods for adding authenticatable signatures to ACKs in accordance with aspects of the present disclosure.

### DETAILED DESCRIPTION

Wireless communications systems may use mechanisms for error-correcting and error-control of transmissions. In some systems, such as Long Term Evolution (LTE) systems, such mechanisms may include hybrid automatic repeat request (HARD) procedures where a transmission is associated with an acknowledgement (ACK) of reception. Similar systems such as automatic repeat request (ARQ) or Wi-Fi ACK may be used in wireless local area networks (WLANs). It may be desirable for a station (STA) and/or access point (AP) to verify that the sender of the ACK is indeed the intended recipient of the original transmission. For example, when using ACKs to determine propagation delay for applications such as ranging, ACKs received from inadvertent or malicious STAs may misrepresent timing delays and throw off determinations (e.g., ranging determinations) associated with STAs assumed to be associated with reception.

To address this issue, ACKs may include an authenticatable signature such as an acknowledgment signature for verification at the original transmitting device. The acknowledgement signature may be determined based on information received from the communication (e.g., a cyclic redundancy check (CRC)), a key shared with the transmitting device, and/or a hash function. In some cases, the acknowledgement signature may be included in a field of an ACK frame or, in some cases, a field of the ACK frame may be manipulated to represent an acknowledgement signature.

Aspects of the disclosure are initially described in the context of a wireless communications system. Examples of wireless systems supporting ACKs with acknowledgement signatures in addition to example ACK frames capable of acknowledgement signatures are then described. Aspects of the disclosure are further illustrated by and described with reference to apparatus diagrams, system diagrams, and flowcharts that relate to adding authenticatable signatures to ACKs.

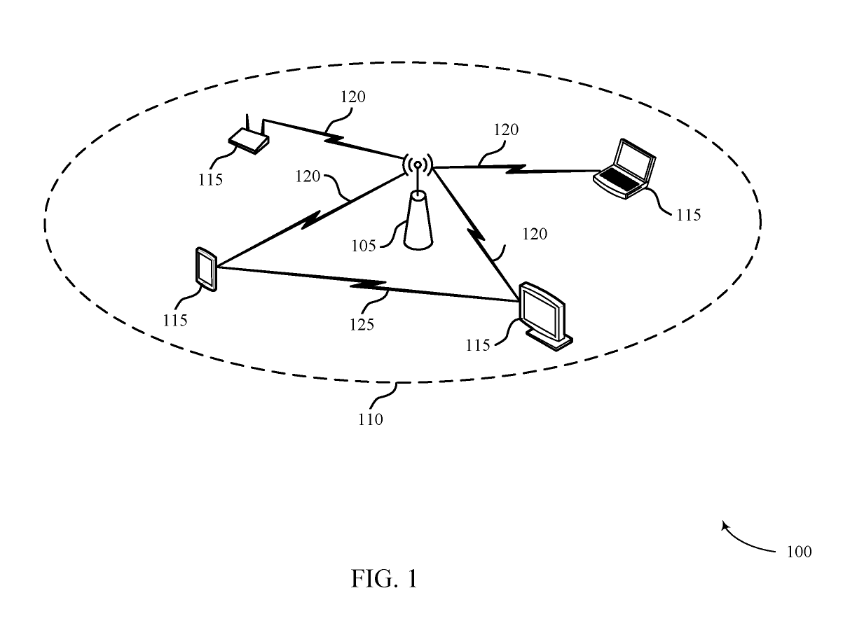

FIG. 1 illustrates a WLAN 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

ARQ may be a method of error-control associated with retransmission of missing or incorrectly received data. Redundant bits of information may be added to data to be transmitted using an error-detecting code. For example, CRC may be implemented along with ARQ. Through ARQ, a new message may be requested from the sender when a message is expected and is not present, when a corrupted message is detected, etc.

A CRC may refer to code added to data used by a receiving device to detect transmission, storage, or retrieval errors. A transmitting device may determine a check value (e.g., a CRC) for a block of data to be sent or stored. In some cases, a receiving device may verify the check value with a known check value. Additionally or alternatively, the receiving device may perform a CRC on the entirety of the data (e.g., the data and the appended check value) and compare the resulting check value with an expected residue constant. If the values at the receiving device do not match, it may be determined the data block contains an error.

HARQ may include ARQ, and both may be methods of ensuring that data is received correctly over a wireless communication link 125. HARQ may include a combination of error detection (e.g., using a CRC), forward error correction (FEC), and retransmission (e.g., ARQ). HARQ may improve throughput at a media access control (MAC) layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission. This may be useful in poor conditions. In other cases, redundancy bits are not added to each transmission, but are retransmitted after the transmitter of the original message receives a negative acknowledgement (NACK) indicating a failed attempt to decode the information. The chain of transmission, response and retransmission may be referred to as a HARQ process. In some cases, a limited number of HARQ processes may be used for a given wireless communication link 125.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless communication link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access/collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

Wireless location technology enables wireless devices to determine their position within an area. Location technology may be supported by satellite systems, cellular networks, WLAN, and other technology. One positioning technique supported by WLAN is the ability to measure the distance or determine the range between two WiFi devices (e.g., an access point and a station or between peer stations) by measuring the time that it takes for a wireless signal to propagate from one device to another. This technique is known as the Fine Timing Measurement (FTM) protocol, which involves a frame exchange between devices regarding the time measurements. The FTM protocol generally improves positioning and navigation, and especially in indoor environments where other positioning techniques may achieve less accurate results. While the FTM protocol may be used by a device to determine its range with another device, the current FTM protocol may lack security enhancements. For example, a malicious user may potentially respond to an FTM measurement frame and hijack the measurement of time and, effectively, the range estimate. For example, when a user is still far away from the user's vehicle, the user's door may open because the car may have estimated that the user is close by. In another example, a user may have the user's cash dispensed at an ATM machine even before the user is close to the ATM. A need exists to authenticate devices involved in the FTM protocol. Various solutions are described in this disclosure. For example, if the devices are associated (e.g., one device is acting as an AP STA and the other device is acting as a STA), the messages used to establish the FTM session can be encrypted or include a code based on the security key established. If the devices are unassociated the messages used to establish the FTM session can include a code based on the security key established out of band (e.g., Bluetooth/Vendor) or during prior association. The acknowledgement signature based on key establishment during FTM session setup may be added to ACK frames and/or FTM frames during the FTM message exchange. In an aspect, the key used to authenticate the messages used to setup an FTM session may be left open or be accomplished out of band.

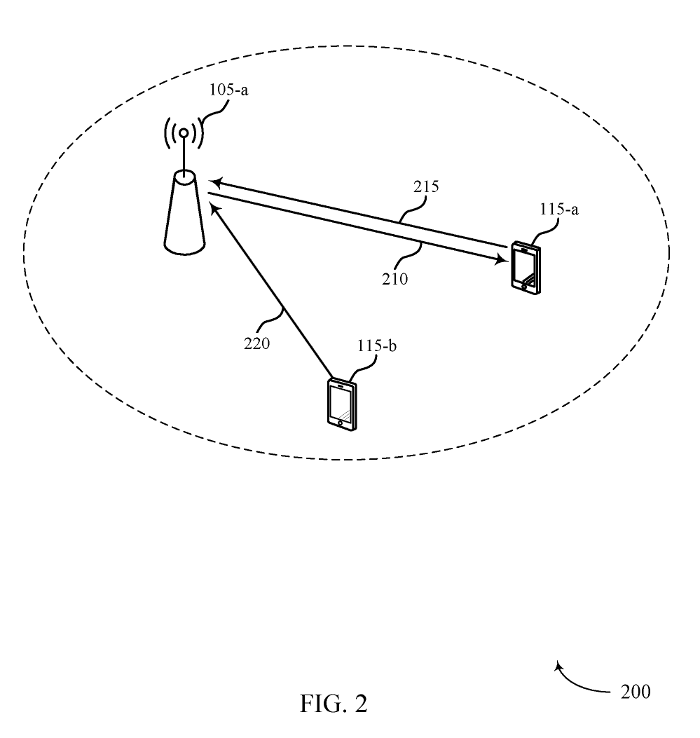

FIG. 2 illustrates an example of a wireless communications system 200 for adding authenticatable signatures such as acknowledgment signatures to ACKs. Wireless communications system 200 may include an initiating AP 105-a and a responding STA 115-a, as well as additional STAs such as STA 115-b, which may be examples of the corresponding devices described with reference to FIG. 1. AP 105-a and STA 115-a may communicate via signals 210 and ACK signals 215. For example, initiating AP 105-a may send a signal 210 to responding STA 115-a. STA 115-a may respond with an ACK signal 215. An ACK frame in ACK signal 215 may include, for example, 14 octets. Such an ACK frame may include fields such as a scrambler seed field, a frame control (FC) field, a Duration field, an A1 or destination field, and a CRC field, as is described below. In some scenarios, the ACK signal 215 may include a block ACK frame, as described below.

Responding AP 105-a and initiating STA 115-a may establish communication and engage in operations including, for example, ranging. In a ranging procedure, initiating AP 105-a may send a signal to responding STA 115-a. Initiating AP 105-a may rely on the assumption that responding STA 115-a may respond with an ACK signal in a specific amount of time (e.g., sixteen microseconds). Initiating AP 105-a may also rely on the assumption that responding STA 115-a may transmit an ACK signal in a specific amount of time (e.g., forty microseconds). However, the further away responding STA 115-a is located from initiating AP 105-a, the more time will pass between AP 105-a sending a message and responding STA 115-a responding with an ACK. Because initiating AP 105-a may know the assumed minimum time that may be taken between sending the message and receiving the ACK, initiating AP 105-a may be able to calculate the distance between the two entities based on the additional time that passes beyond the minimum time.

Current protocol such as ranging protocol may be vulnerable, however, because an ACK frame may not contain any kind of authentication information. That is, a malicious STA or an inadvertent STA (e.g., additional STA 115-b) in a WiFi system may be in possession of information (e.g., the address of the AP) that allows it to send an ACK to initiating AP 105-a. Initiating AP 105-a may have no way to determine whether a received ACK signal originated with responding STA 115-a or some other malicious or inadvertent STA (e.g., additional STA 115-b). Thus, a lack of authentication information in an ACK signal may negatively affect the reliability and accuracy of a ranging procedure. However, if responding STA 115-a adds authenticating information to the ACK signal, initiating AP 105-a may be able to differentiate between ACK signals sent by malicious or inadvertent STAs (e.g., additional STA 115-b), and an ACK signal sent by responding STA 115-a.

Responding STA 115-a may add an acknowledgment signature to the ACK frame, consisting of authenticating information based on an encryption key that has been shared by the two devices (e.g., the responding STA 115-a and the initiating AP 105-a). That is, responding STA 115-a may generate authenticating information in the form of an acknowledgement signature. The acknowledgement signature may be based, at least in part, on an encryption key exchanged between the responding STA 115-a and the initiating AP 105-a prior to a ranging procedure. The responding STA 115-a may include the acknowledgement signature in the content of an ACK frame to be sent to the responding 105-a. Upon reception of the ACK frame, the initiating AP 105-a may read the authenticating information and thereby verify that the ACK signal 215 is indeed from the responding STA 115-a. In some example, the ACK fame may be a fine timing measurement (FTM) response frame of a first FTM frame.

The responding STA 115-a may generate the acknowledgement signature as a combination of various types of information, including information from a soliciting signal 210. For example, the responding STA 115-a may use a Timing Synchronization function (TSF) in generating an acknowledgment signature. A TSF may ensure that each of the communicating devices has a common understanding of time (e.g., that each device is keeping time in an identical manner). Additionally, the responding STA 115-a may apply a sequence number to generate an acknowledgment signature. The sequence number may be received by the responding STA 115-a as part of soliciting signal 210 and may ensure that packets are received in the correct order, or without duplicates. Further, soliciting signal 210 may also include a CRC for detection of accidental changes in data upon reception. The CRC may also be used by the responding STA 115-a to generate the acknowledgement signature. Therefore, responding STA 115-a may generate an acknowledgement signature using one or more of the TSF, sequence numbers, and/or fields of the soliciting frame including the CRC. Additionally, responding STA 115-a may embed the acknowledgement signature in an ACK signal or a block ACK, such as ACK signal 215. In some cases, the soliciting frame may be a FTM response or a first FTM frame.

In some examples, responding STA 115-a may determine a scrambler seed based on the acknowledgment signature, and then apply the scrambler seed to an ACK frame of ACK signal 215. When transmitting a signal, the transmitted information in the form of ones and zeros may be used to create a waveform. If STA 115-a creates a waveform that represents too many ones or zeros in a row, the waveform may be negatively affected such that the waveform is difficult to read. Thus, responding STA 115-a may apply a scrambler seed to a signal (such as an ACK signal 215) to ensure that there is sufficient toggling between ones and zeros such that the signal is readable. The scrambler seed may be based on the acknowledgement signature. In some examples, responding STA 115-a may select seven bits of the scrambler seed for the ACK from the acknowledgment signature. In some cases, the frame control field may include sixteen bits and the acknowledgement signature may be inserted into a least significant eight bits of the sixteen bits of the frame control field. In another aspect, a most significant bit of the duration field may be set to 1 to indicate that the duration field includes the acknowledgement signature, and a remaining set of bits in the duration field may include the acknowledgement signature. In another aspect, the receive address field may include the acknowledgement signature. In another aspect, the CRC field may be based on the acknowledgement signature. In another aspect, the ACK frame may be generated by concatenating the acknowledgement signature with the scrambler seed field, the frame control field, the duration field, and/or the receive address field, by calculating the CRC information based on the concatenation, and by inserting the CRC information into the CRC field. That is, the acknowledgment signature may be concatenated with the scrambler seed field, the frame control field, the duration field, and/or the address field to generate a value to be inserted into the CRC field. For purposes of concatenating the acknowledgment signature, the acknowledgment signature may be placed before the scrambler seed or after the address field. Thus, the scrambler seed field of the ACK frame may also contain the acknowledgement signature. The ACK signal 215 may be scrambled in accordance with the scrambler seed, meaning that descrambling of the ACK signal 215 by initiating AP 105-a may be performed through knowledge and/or recognition of the acknowledgement signature by the initiating AP 105-a.

In some examples, responding STA 115-a may embed the acknowledgement signature in the frame control field of the ACK frame. A frame control field may include two octets. The first octet may include essential fields that identify the protocol, type, and sub type fields that indicate that the frame is an ACK frame. The second octet fields, which may be useful for other types of signals, may not be necessary for an ACK. For example, a retry bit, which is normally included in the second octet of a frame control field, may be unnecessary in an ACK because the ACK signal is either successful or it is not; no retry is applicable. Thus, the second octet of the frame control field may be available for alternative use. Responding STA 115-a may generate an acknowledgement signature, which it may embed in this available second octet.

In other examples, responding STA 115-a may embed the acknowledgement signature in the duration field of the ACK frame. A duration field may include two octets, and may be used to reserve a specific amount of time to transmit on the medium. The duration frame may inform listening entities that the medium is reserved, even if the listening entities did not hear the initial transmission. In examples that involve transmitting significant amounts of data, the duration field may be of great use. However, some examples include one round transmissions; that is, some communications include a single transmission followed by an ACK. In such examples, responding STA 115-a may set the duration field to zero because the STA 115-a may have no need to reserve the medium beyond the transmission of the ACK. In such examples, this leaves the two octets of the duration field in which responding STA 115-a may embed an acknowledgement signature. An indication in the duration field (e.g., a most significant bit (MSB) being set to one) may specify whether the two octets of the duration field include an acknowledgement signature. Thus, upon setting the MSB to one, fifteen bits become available for embedding an acknowledgement signature. This approach may be advantageous because it provides fifteen bits with which to work, as opposed to only eight available in the frame control field. This approach may also be advantageous in one round communications, such as ranging procedures.

Further, responding STA 115-a may embed the acknowledgement signature in the A1 field of the ACK frame. An A1 field may include six octets, and may carry information concerning the address of the initiating AP 105-a. The A1 field may be used by the recipient of the ACK to notify the initiating AP 105-a that the initiating AP 105-a is the intended recipient of the ACK signal 215. For any other entity, the field may be useless. Thus, the purpose of the A1 field might be achieved by any transmitted quantity (e.g., an acknowledgement signature) known by both initiator and responder. Responding STA 115-a may use one or more of the six octets to embed an acknowledgement signature.

In some examples, responding STA 115-a may determine a CRC for the ACK based on the acknowledgement signature, and include the CRC in the ACK frame. A CRC field may be used by the initiating AP 105-a to verify that all data was correctly received. This field may have no significance for any entity other than AP 105-a, because other listening entities may have no interest in whether STA 115-a correctly received its data. A CRC field may be filled with information based on a standard algorithm to indicate reception of all data. This algorithm may be adjusted to include an acknowledgement signature, meaning that the CRC itself may be generated based on an acknowledgement signature.

Additionally or alternatively, responding STA 115-a may embed an acknowledgement signature in an encrypted ACK signal. An encrypted ACK signal may identify itself via the type and subtype sub-fields of a frame control field. A frame control field may comprise two octets, the second of which may include a Wired Equivalent Privacy (WEP) bit. When a WEP bit is set to one, initiating AP 105-a may know to look for a Counter Mode Cipher Block Chaining Message Authentication Code Protocol (CCMP) header and a Message Integrity Check (MIC). For such an ACK signal, there may be no data found in the field between the CCMP header and the MIC. Instead, responding STA 115-a may determine an acknowledgement signature based on the encryption header (in some cases the CCMP header) and the MIC may comprise the acknowledgement signature.

In some examples, responding STA 115-a may embed an acknowledgement signature in an encrypted Block ACK signal. A block ACK may include a CCMP header, a block ACK (BA) control field, a BA information field, and a MIC field. In some examples, the BA control field and the BA information field may not be encrypted, even though the BA control field and the BA information field may be located between a CCMP header and a MIC field. As a purpose of including the CCMP header and the MIC field in a block ACK may be for authentication purposes only (which may be performed using the MIC field), there may not be a need to encrypt the BA control field and BA information field. In such examples, significant computer processing time may be saved. In an encrypted block ACK, responding STA 115-a may not determine an acknowledgement signature by using TSF information. Rather, responding STA 115-a may determine an acknowledgement signature using sequence numbers, because a CCMP field may have its own dynamic sequence number. The responding STA 115-a may determine an acknowledgement signature based on the encryption header (in some cases the CCMP header) without encrypting the BA control field or the BA information field, and the MIC may comprise the acknowledgement signature.

Additionally, responding STA 115-a may include a control wrapper in the frame. In such an example, the ACK frame may be located between the CCMP Header and the MIC. The responding STA 115-a may determine an acknowledgement signature based on the encryption header (in some cases the CCMP header) and the MIC may comprise the acknowledgement signature.

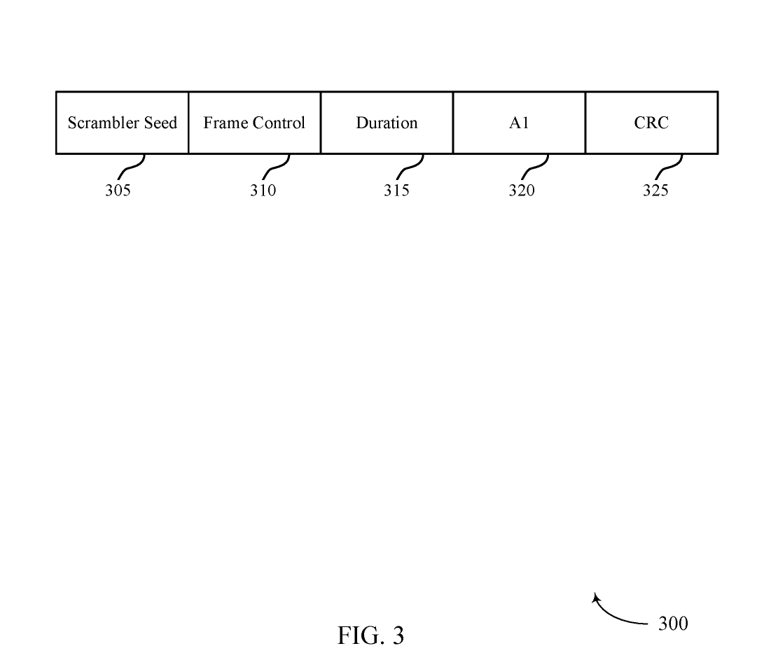

FIG. 3 illustrates an example of an ACK frame 300 for adding authenticatable signatures such as acknowledgment signatures to ACKs. In some cases, the ACK frame 300 may represent aspects of techniques performed by a STA 115 and an AP 105 as described with reference to FIGS. 1-2. In some cases, responding STA 115-a may determine an acknowledgement signature and include it in one or more fields of ACK frame 300.

ACK frame 300 may include a scrambler seed field 305. When transmitting a signal, the transmitted information in the forms of ones and zeros may be used to create a waveform. If STA 115-a creates a waveform that represents too many ones or zeros in a row, the waveform may be negatively affected such that the waveform is difficult to read. A scrambler seed, when applied to a signal (such as an ACK signal 215), adjusts the data to ensure that there is sufficient toggling between ones and zeros and thus that the signal is readable. The scrambler seed may be based on the acknowledgement signature. Responding STA 115-a may determine a scrambler seed based on the acknowledgment signature, and then apply the scrambler seed to the frame. In some examples, responding STA 115-a may select seven bits of scrambler seed field 305 for the ACK from the acknowledgement signature. The ACK signal 215 may be scrambled in accordance with the scrambler seed, meaning that descrambling of the ACK signal 215 by initiating AP 105-a may be performed through knowledge and/or recognition of the acknowledgement signature by the initiating AP 105-a.

ACK frame 300 may include a frame control field 310. Frame control field 310 may include two octets. The first octet may include essential fields that identify the protocol, type, and sub type fields that indicate that the frame is an ACK frame. The second octet fields, which may be useful for other types of signals, may not be necessary for an ACK signal. For example, a retry bit, which is normally included in the second octet of a frame control field, may be unnecessary in an ACK because the ACK signal is either successful or it is not; no retry is applicable. The second octet fields may be reserved for the ACK signal. Responding STA 115-a may determine an acknowledgement signature, which it may embed in this available octet.

ACK frame 300 may include a duration field 315. Duration field 315 may include two octets, and may inform listening entities that the medium is reserved, even if the listening entities did not hear the initial transmission. In scenarios that involve transmitting significant amounts of data, the duration field may be of great use. However, in some examples, communications include a single transmission followed by an ACK. In such examples, responding STA 115-a may set the duration field 315 to zero because the STA 115-a may have no need to reserve the medium beyond the transmission of the ACK. In such examples, this leaves the two octets of the duration field in which the responding STA may embed an acknowledgement signature.

ACK frame 300 may include an A1 field 320. A1 field 320 may include six octets, and may carry information concerning the address of the initiating AP 105-a. The A1 field may be used by the recipient of the ACK to notify initiating AP 105-a that the initiating AP 105-a is the intended recipient of the ACK signal 215. For any other entity, the field may be useless. However, the purpose of the A1 field 320 might be achieved by any transmitted quantity (e.g., an acknowledgement signal) known by both responding STA 115-a and initiating AP 105-a. Responding STA 115-a may use one or more of the available six octets to embed an acknowledgement signature.

ACK frame 300 may include CRC field 325. CRC field 325 may be used by initiating AP 105-a to verify that all data was correctly received. A CRC field may be filled with information based on a standard algorithm. This algorithm could be adjusted to include an acknowledgement signature, meaning that the CRC itself may be generated based on an acknowledgement signature. Thus, responding STA 115-a may determine a CRC for the ACK based on the acknowledgement signature, and include the determined CRC in the ACK frame.

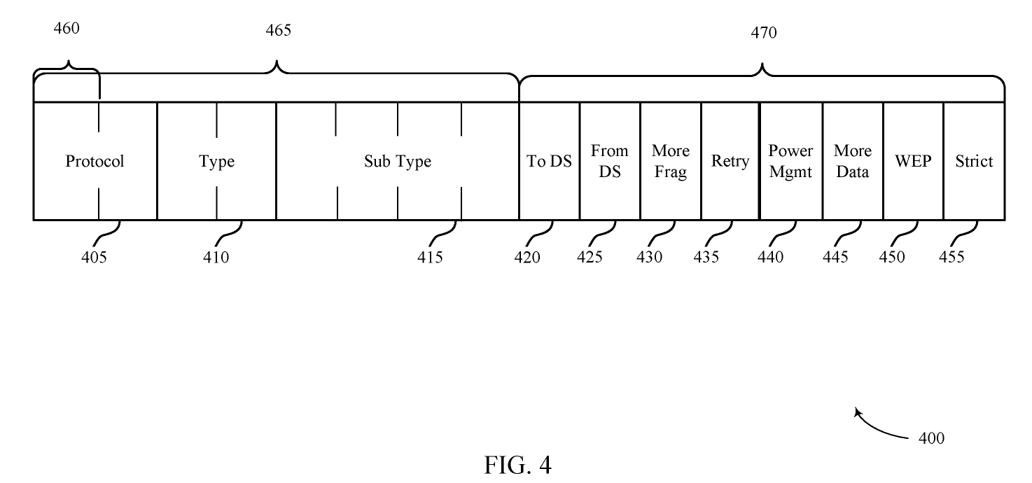

FIG. 4 illustrates an example of a frame control field 400 for adding authenticatable signatures such as acknowledgment signatures to ACKs. In some cases, frame control field 400 may represent aspects of techniques performed by a STA 115 an AP 105 as described with reference to FIGS. 1-3. In some cases, frame control field 400 may represent aspects of frame control field 310.

Frame control field 400 may include a first octet 465 and second octet 470. First octet 465 may include protocol subfield 405, type subfield 410, and sub type subfield 415. Protocol subfield 405, type subfield 410, and sub type subfield 415 may include essential fields that identify the protocol, type, and sub type fields that indicate that the frame is an ACK frame.

Frame control field 400 may include a second octet 470. Second octet 470 may include eight subfields (e.g., fields 420-455). Frame control field 400 may comprise bits 460 (e.g., 16 bits). Second octet 470 may be reserved for the ACK signal. However, bits 460 in fields 420-455 (e.g., bits 460 in second octet 470) may not be necessary for an ACK signal. Thus, second octet 470 containing fields 420-455 may be manipulated to contain the acknowledgement signature according to the scenarios as described with reference to FIGS. 1-3 above.

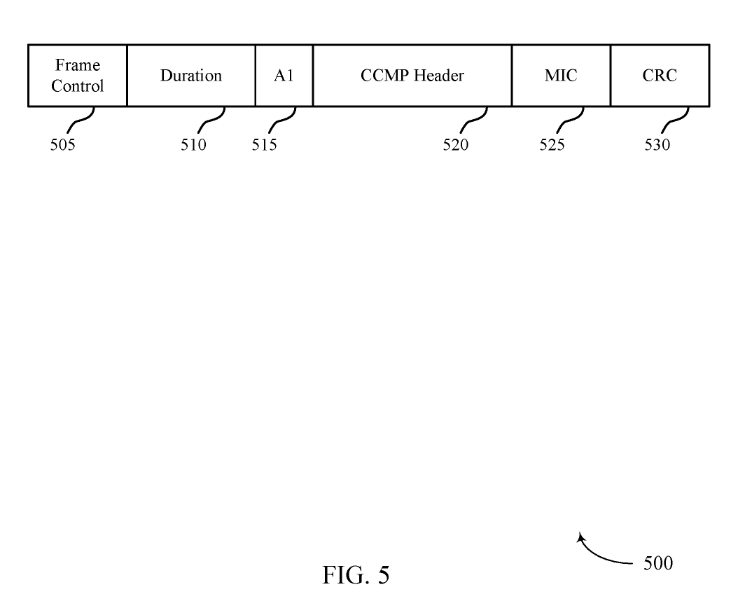

FIG. 5 illustrates an example of an ACK frame 500 for adding authenticatable signatures such as acknowledgment signatures to ACKs. In some cases, encrypted ACK frame 500 may represent aspects of techniques performed by STA 115 and AP 105 as described with reference to FIGS. 1-4.

ACK frame 500 may include frame control field 505. Frame control field 505 may include two octets. The first octet may include essential fields that identify the protocol, type, and sub type fields that indicate that the frame is an ACK frame. The second octet may be reserved for the ACK signal. However, the bits in the second octet may not be necessary for an ACK signal. Thus, the second octet may be manipulated to contain the acknowledgement signature according to the scenarios as described with reference to FIGS. 1-3 above.

ACK frame 500 may include duration field 510. Duration field 510 may inform listening entities that the medium is reserved. Encrypted ACK frame 500 may include A1 field 515. A1 field 515 may include six octets, and may carry information concerning the address of the initiating AP 105-a.

ACK frame 500 may also include a CCMP header field 520. CCMP header field 520 may indicate the use of a strong encryption protocol. CCMP header field 520 may include its own sequence number that changes from frame to frame, rendering time tracking moot. As discussed below, responding STA 115-a may determine an acknowledgement signature based on CCMP header field 520.

ACK frame 500 may include a MIC field 525. MIC field 525 may provide an integrity check for the rest of the transmission. There may be no data found in a field between CCMP header field 520 and MIC field 525. Instead, responding STA 115-a may determine an acknowledgement signature based on the encryption header (in some cases CCMP header field 520) and MIC field 525 may comprise the acknowledgement signature. ACK frame 500 may also include a CRC field 530.

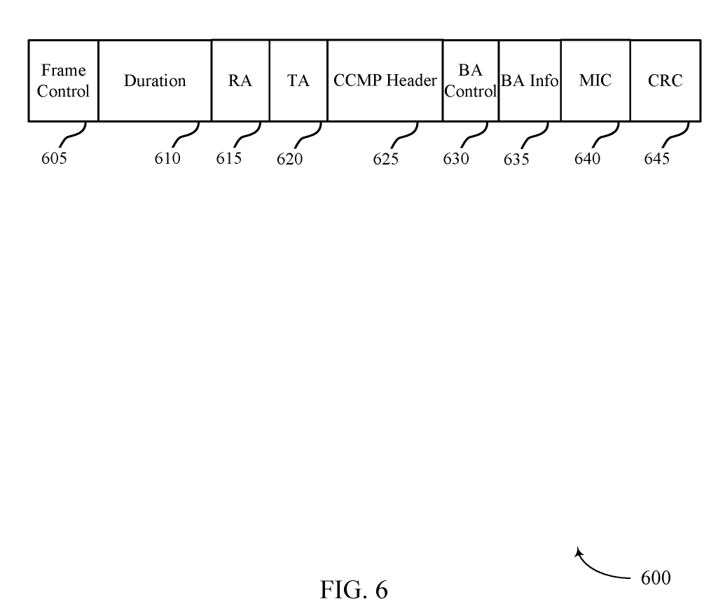

FIG. 6 illustrates an example of a block ACK 600 for adding authenticatable signatures such as acknowledgment signatures to ACKs. In some cases, encrypted block ACK 600 may represent aspects of techniques performed by STA 115 and AP 105 as described with reference to FIGS. 1-5. Block ACK 600 may include frame control field 605. Frame control field 605 may include two octets. The first octet may include essential fields that identify the protocol, type, and sub type fields that indicate that block ACK 600 is an ACK frame. The second octet fields may be reserved for the ACK signal.

Block ACK 600 may include duration field 610. Duration field 610 may inform listening entities that the medium is reserved. Additionally a receiver address (RA) field 615 and a transmitter address (TA) field 620 may be included. RA field 615 may comprise the destination address of a frame. TA field 620 may comprise a transmitter address identifying the entity that transmitted the frame.

Block ACK 600 may include a CCMP header field. CCMP header field 625 may indicate the use of a strong encryption protocol. CCMP header field 625 may include its own sequence number that changes from frame to frame, rendering time tracking moot. As discussed below, responding STA 115-a may determine an acknowledgement signature based on the encryption header (in some cases CCMP header field 625), and the MIC may comprise the acknowledgement signature.

Block ACK 600 may include a BA control field 630 and a BA information field 635. BA control field 630 and BA information field 635 may comprise a payload for the frame. The data contained in BA control field 630 and BA information field 635 may be encrypted or may not be encrypted.

Block ACK 600 may include a MIC field 640. MIC field 640 may provide an integrity check for the rest of the transmission. The responding STA 115-a may determine an acknowledgement signature based on the encryption header (in some cases the CCMP header) and the MIC field 640 may comprise the acknowledgement signature.

Block ACK 600 may include a CRC field 645. A CRC field 645 may indicate to initiating AP 105-a that all data was correctly received. In some cases, this field may have no significance for any entity other than the receiving entity.

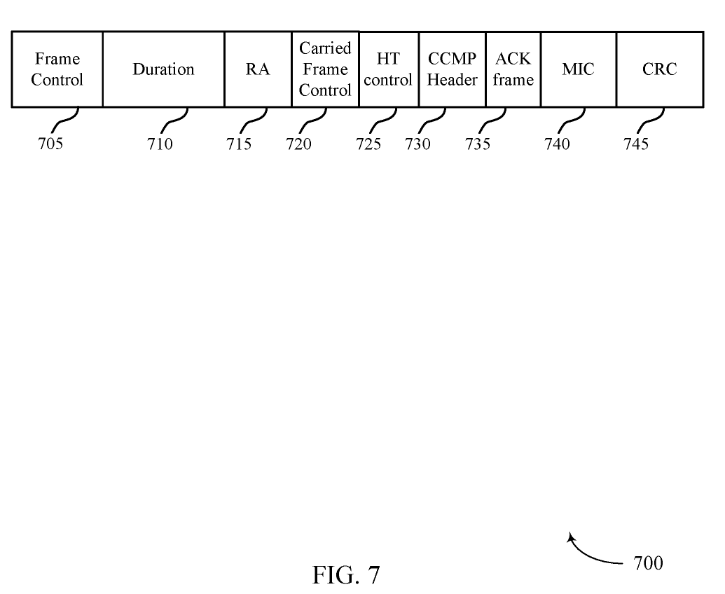

FIG. 7 illustrates an example of an ACK frame 700 for adding authenticatable signatures such as acknowledgment signatures to ACKs. In some cases, an ACK frame including an ACK frame 700 may represent aspects of techniques performed by STA 115 and AP 105 as described with reference to FIGS. 1-6. Responding STA 115-a may embed an acknowledgement signature in a control wrapper for encrypted ACK signals.

ACK frame 700 may include frame control field 705. Frame control field 705 may include two octets. The first octet may include essential fields that identify the protocol, type, and sub type fields that indicate that the frame is an ACK frame. The second octet fields may be reserved for the ACK signal. ACK frame 700 may include duration field 710. Duration field 710 may inform listening entities that the medium is reserved.

ACK frame 700 may include RA field 715. RA field 715 may comprise the destination address of a frame. RA field 715 may include six octets, and may carry information concerning the address of the initiating AP 105-a. ACK frame 700 may include carried frame control field 720, which may contain information indicating the type of frame. ACK frame 700 may include a high throughput (HT) control field 725, which may include four octets.

ACK frame 700 may also contain a CCMP header field 730. CCMP header field 730 may indicate the use of a strong encryption protocol. CCMP header field 730 may include its own sequence number that changes from frame to frame, rendering time tracking moot. As discussed below, responding STA 115-a may determine an acknowledgement signature based on the encryption header (in some cases CCMP header field 730), and the MIC may comprise the acknowledgement signature. ACK frame 700 may also contain an

ACK frame field 735. ACK frame field 735 may contain the acknowledgement signal and may be located between CCMP header field 730 and MIC field 740.

ACK frame 700 may include MIC field 740 and CRC field 745. MIC field 740 may provide an integrity check for the rest of the transmission. Responding STA 115-a may determine an acknowledgement signature based on the encryption header (in some cases the CCMP header field 730) and MIC field 740 may comprise the acknowledgement signature.

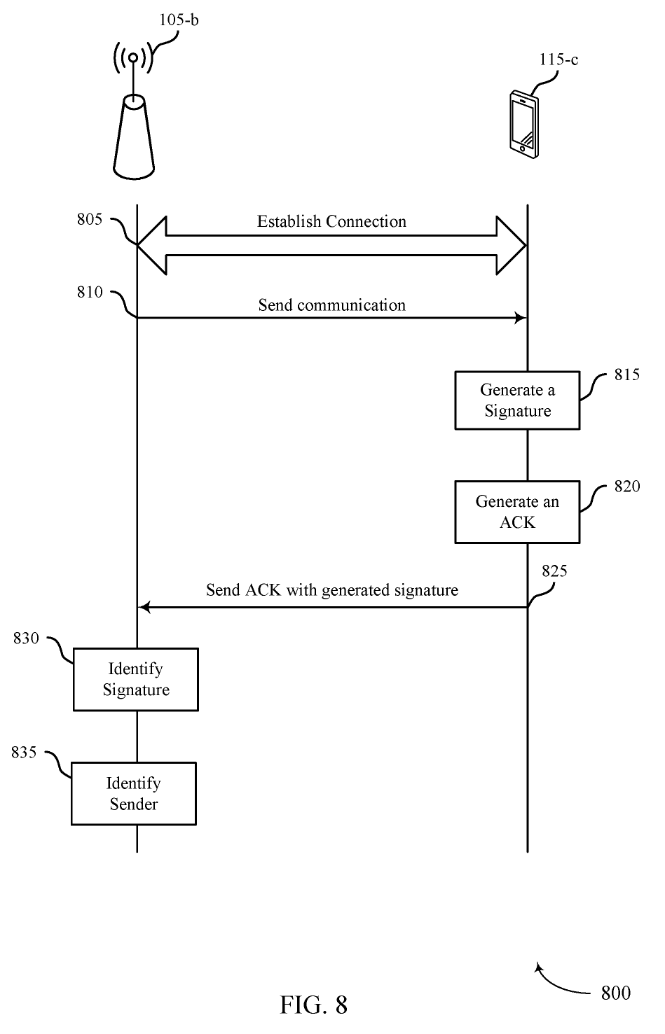

FIG. 8 illustrates an example of a process flow 800 for adding authenticatable signatures such as acknowledgment signatures to ACKs. Process flow 800 may include responding STA 115-c and AP 105-b, which may be examples of or which may represent aspects of techniques performed by a STA 115 or an AP 105 as described with reference to FIGS. 1-7.

At step 805, responding STA 115-c and initiating AP 105-b may establish a connection. The two entities may share an encryption key via the link or connection established at step 805. At step 810, AP 105-b may send a communication, and STA 115-c may receive communication at step 810. Then, at step 815, STA 115-c may determine a unique acknowledgement signature for authentication with AP 105-b. The signature may include identifying information in combination with the encryption key shared at step 805. Furthermore, responding STA 115-c may determine the acknowledgement signature based at least in part on information from the received communication (which may include a CRC), the key shared with the wireless device, and/or a hash function.

The responding STA 115-c may determine a scrambler seed based on the acknowledgment signature, and then apply the scrambler seed to the frame. Alternatively, responding STA 115-c may include the acknowledgment signature in at least one of the frame control field, A1 field, or duration field. If responding STA 115-c includes the acknowledgement signature in a duration field, it may elect to set the MSB of the duration field to one. Responding STA 115-c may base a CRC for the acknowledgment at least in part on the acknowledgment signature, and include the signature in the CRC field. Alternatively, responding STA 115-c may include an encryption header within the frame and determine a MIC for the ACK based on and encryption header, and may further use the MIC as an acknowledgement signature.

In some examples, the acknowledgement may comprise a block ACK, which includes an encryption header, a BA control field, and a BA information field. In such examples, responding STA 115-c may determine a MIC for the ACK based on the encryption header, but not encrypt the BA control field or the BA information field. In such examples, the MIC may comprise the acknowledgment signature. Further, the encryption header may be a Counter Mode with a CCMP header. Alternatively, responding STA 115-c may include a control wrapper in the frame, and may wrap the acknowledgement between an encryption header and a message. In such examples, the MIC may comprise the acknowledgement signature.

Next, at step 820, STA 115-c may determine an ACK signal. The ACK signal may be based at least in part on the acknowledgment signature. STA 115-c may transmit an ACK signal for the communication at step 810 to AP 105-b. ACK signal 825 may include a transmission frame for the ACK signal that is based at least in part on the acknowledgment signature.

Based on ACK signal 825, which includes the determined signature from step 815, the AP 105-b may identify the signature at step 830. Then, at step 835, AP 105-b may identify the sender.

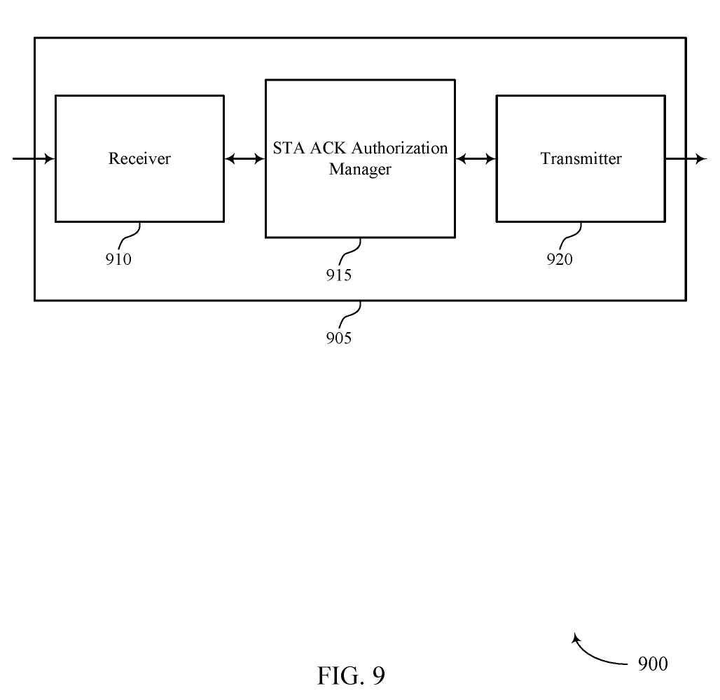

FIG. 9 shows a block diagram 900 of a wireless device 905 that supports adding authenticatable signatures such as acknowledgment signatures to ACKs in accordance with various aspects of the present disclosure. Wireless device 905 may be an example of aspects of a STA 115 as described with reference to FIG. 1. Wireless device 905 may include receiver 910, STA ACK authorization manager 915, and transmitter 920. Wireless device 905 may also include a processor. Each of these components may be in communication with one another (e.g., via one or more buses).

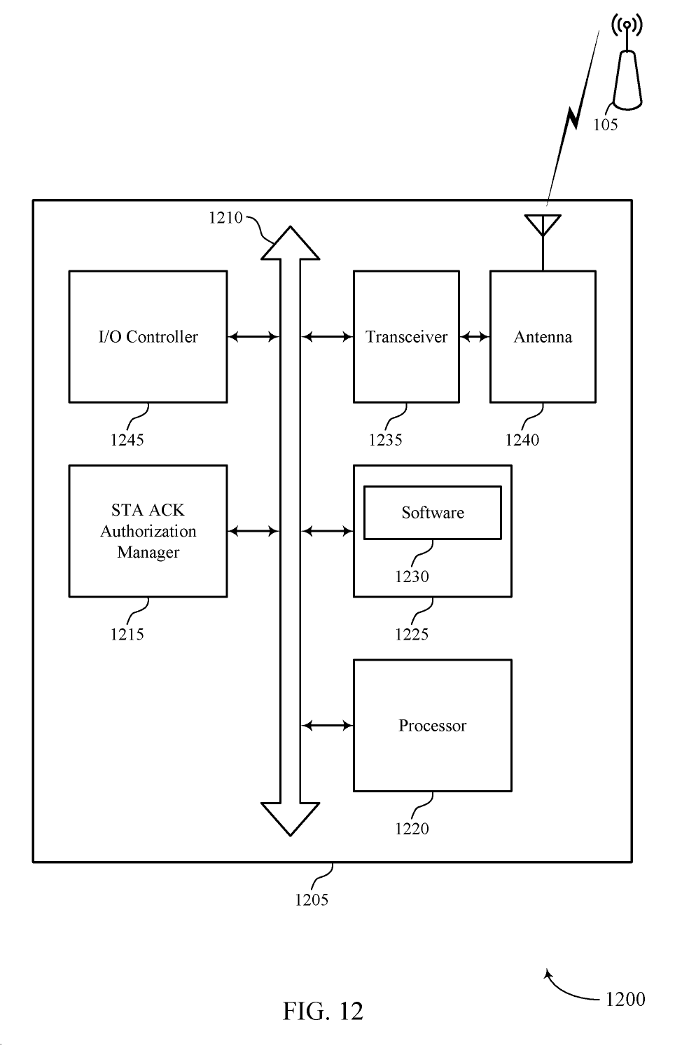

Receiver 910 may receive information such as packets, user data, or control information associated with various information channels (e.g., control channels, data channels, and information related to adding authenticatable signatures to ACKs, etc.). Information may be passed on to other components of the device. The receiver 910 may be an example of aspects of the transceiver 1235 described with reference to FIG. 12.

STA ACK authorization manager 915 may be an example of aspects of the STA ACK authorization manager 1215 described with reference to FIG. 12. STA ACK authorization manager 915 may receive a communication from a wireless device, determine an acknowledgement signature for authentication with the wireless device, the acknowledgement signature being based on a key shared with the wireless device, and transmit a frame including an acknowledgement for the communication to the wireless device, where content of the frame is based on the acknowledgement signature.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may include a single antenna, or it may include a set of antennas.

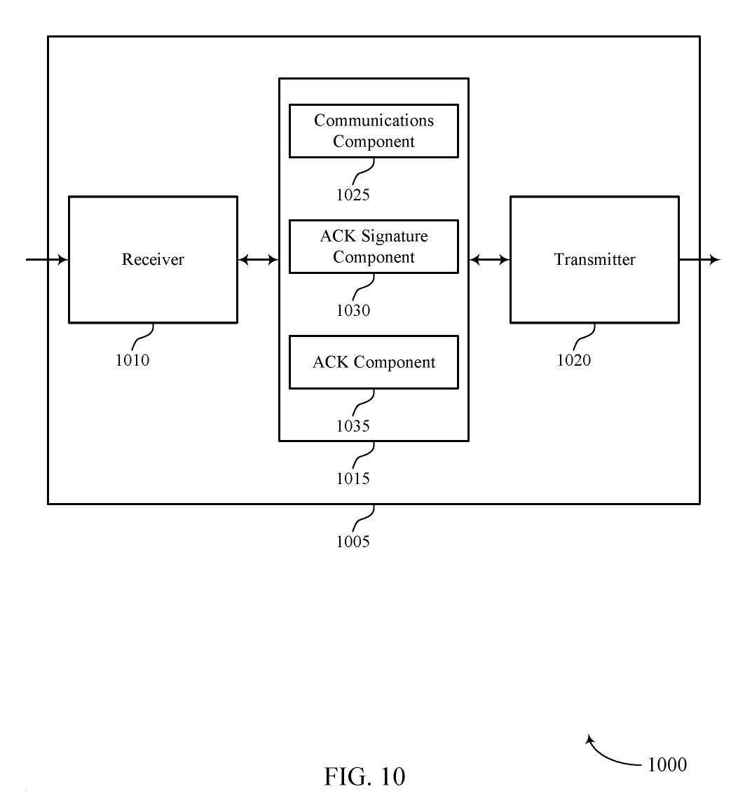

FIG. 10 shows a block diagram 1000 of a wireless device 1005 that supports adding authenticatable signatures such as acknowledgment signatures to ACKs in accordance with various aspects of the present disclosure. Wireless device 1005 may be an example of aspects of a wireless device 905 or a STA 115 as described with reference to FIGS. 1 and 9. Wireless device 1005 may include receiver 1010, STA ACK authorization manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to adding authenticatable signatures to ACKs, etc.). Information may be passed on to other components of the device. The receiver 1010 may be an example of aspects of the transceiver 1235 described with reference to FIG. 12.

STA ACK authorization manager 1015 may be an example of aspects of the STA ACK authorization manager 1215 described with reference to FIG. 12. STA ACK authorization manager 1015 may also include communications component 1025, ACK signature component 1030, and ACK component 1035.

Communications component 1025 may receive a communication from a wireless device. In some cases, the information from the received communication includes a CRC. ACK signature component 1030 may determine an acknowledgement signature for authentication with the wireless device, the acknowledgement signature being based on a key shared with the wireless device, include the acknowledgement signature in the frame based on the determination, and include the acknowledgement signature in an address field of the frame. In some cases, determining the acknowledgement signature includes determining a unique signature based on information from the received communication, the key shared with the wireless device, and a hash function.

ACK component 1035 may determine that the acknowledgement is to be used by the wireless device for range finding. ACK component 1035 may transmit a frame including an acknowledgement for the communication to the wireless device, where content of the frame is based on the acknowledgement signature. ACK component 1035 may include the acknowledgement signature in a frame control portion of the frame, include the acknowledgement signature in a duration field of the frame, set a MSB of the duration field to one, and/or include a control wrapper in the frame such that the acknowledgement is wrapped between an encryption header and a MIC. In some cases, the MIC may be the acknowledgement signature. In some cases, the acknowledgement includes a block acknowledgement.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may include a single antenna, or it may include a set of antennas.

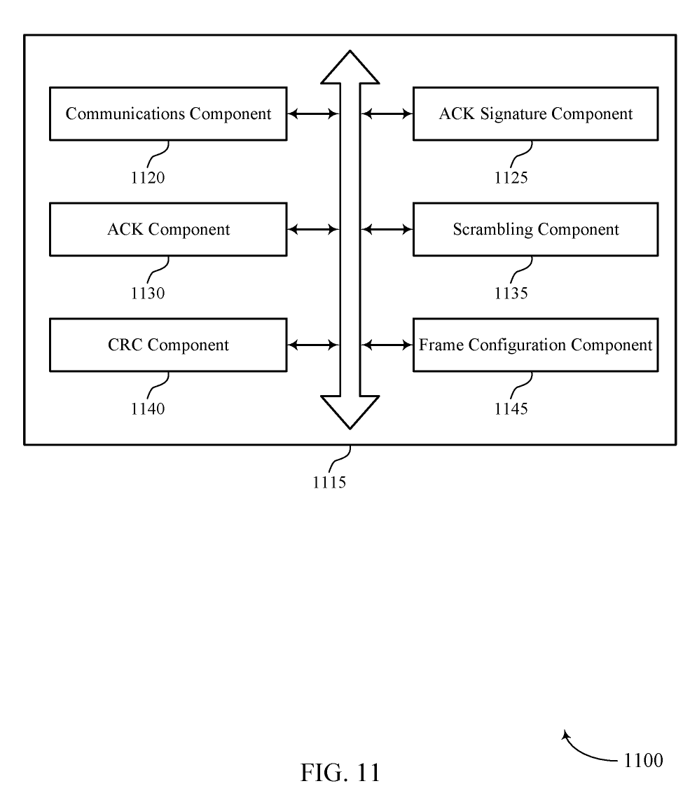

FIG. 11 shows a block diagram 1100 of a STA ACK authorization manager 1115 that supports adding authenticatable signatures such as acknowledgment signatures to ACKs in accordance with various aspects of the present disclosure. The STA ACK authorization manager 1115 may be an example of aspects of a STA ACK authorization manager 915, a STA ACK authorization manager 1015, or a STA ACK authorization manager 1215 described with reference to FIGS. 9, 10, and 12. The STA ACK authorization manager 1115 may include communications component 1120, ACK signature component 1125, ACK component 1130, scrambler component 1135, CRC component 1140, and frame configuration component 1145. Each of these modules may communicate, directly or indirectly, with one another (e.g., via one or more buses).

Communications component 1120 may receive a communication from a wireless device. In some cases, the information from the received communication includes a CRC. ACK signature component 1125 may determine an acknowledgement signature for authentication with the wireless device, the acknowledgement signature being based on a key shared with the wireless device. ACK signature component 1125 may include the acknowledgement signature in the frame based on the determination, and include the acknowledgement signature in an address field of the frame. In some cases, determining the acknowledgement signature includes determining a unique signature based on information from the received communication, the key shared with the wireless device, and a hash function.

ACK component 1130 may determine that the acknowledgement is to be used by the wireless device for range finding. ACK component 1130 may transmit a frame including an acknowledgement for the communication to the wireless device, where content of the frame is based on the acknowledgement signature. ACK component 1130 may include the acknowledgement signature in a frame control portion of the frame, include the acknowledgement signature in a duration field of the frame, set a MSB of the duration field to one, and/or include a control wrapper in the frame such that the acknowledgement is wrapped between an encryption header and a MIC. In some cases, the MIC is the acknowledgement signature. In some cases, the acknowledgement includes a block acknowledgement.

Scrambler component 1135 may determine a scrambler seed based on the acknowledgement signature and apply the scrambler seed to the frame. CRC component 1140 may determine a CRC for the acknowledgement based on the acknowledgement signature and include the CRC in the frame.

Frame configuration component 1145 may include an encryption header within the frame and determine an MIC for the acknowledgement based on the encryption header, where the MIC is the acknowledgement signature. Frame configuration component 1145 may also include an encryption header, a block acknowledgement control field and a block acknowledgement information field within the frame. Frame configuration component 1145 may further determine a MIC for the acknowledgement based on the encryption header without encrypting the block acknowledgement control field and the block acknowledgement information field, where the MIC is the acknowledgement signature. In some cases, the encryption header is a CCMP header.

FIG. 12 shows a diagram of a system 1200 including a device 1205 that supports adding authenticatable signatures such as acknowledgment signatures to ACKs in accordance with various aspects of the present disclosure. Device 1205 may be an example of or include the components of wireless device 905, wireless device 1005, or a STA 115 as described above, e.g., with reference to FIGS. 1, 9 and 10. Device 1205 may include components for bi-directional voice and data communications including components for transmitting and receiving communications, including STA ACK authorization manager 1215, processor 1220, memory 1225, software 1230, transceiver 1235, antenna 1240, and I/O controller 1245. These components may be in electronic communication via one or more busses (e.g., bus 1210).

Processor 1220 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting adding authenticatable signatures to ACKs).1220.

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a basic input/output system (BIOS) which may control basic hardware and/or software operation such as the interaction with peripheral components or devices.

Software 1230 may include code to implement aspects of the present disclosure, including code to support adding authenticatable signatures to ACKs. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system.

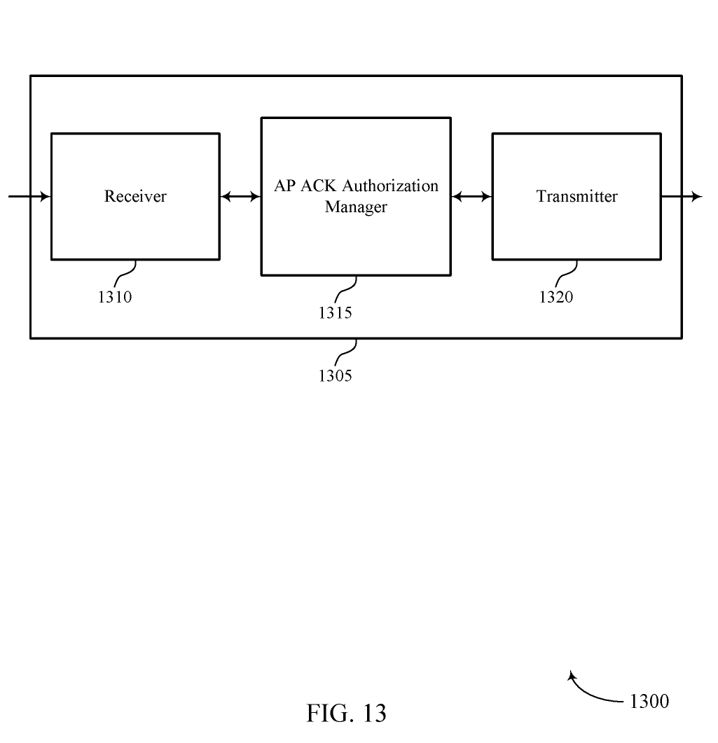

FIG. 13 shows a block diagram 1300 of a wireless device 1305 that supports adding authenticatable signatures such as acknowledgment signatures to ACKs in accordance with various aspects of the present disclosure. Wireless device 1305 may be an example of aspects of an AP 105 as described with reference to FIG. 1. Wireless device 1305 may include receiver 1310, AP ACK authorization manager 1315, and transmitter 1320. Wireless device 1305 may also include a processor. Each of these components may be in communication with one another (e.g., via one or more buses).

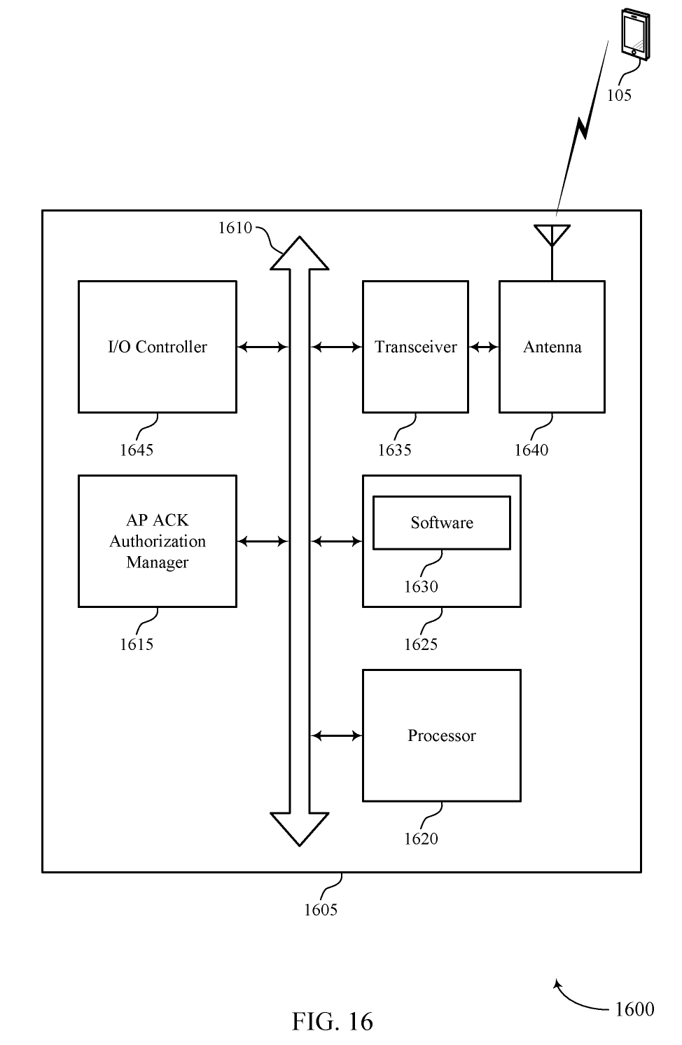

Receiver 1310 may receive information such as packets, user data, or control information associated with various information channels (e.g., control channels, data channels, and information related to adding authenticatable signatures to ACKs, etc.). Information may be passed on to other components of the device. The receiver 1310 may be an example of aspects of the transceiver 1635 described with reference to FIG. 16.

AP ACK authorization manager 1315 may be an example of aspects of the AP ACK authorization manager 1615 described with reference to FIG. 16. AP ACK authorization manager 1315 may transmit a communication to a wireless device, receive a frame including an acknowledgement for the communication from the wireless device, identify an acknowledgement signature from content of the frame, the acknowledgement signature being based on a key shared with the wireless device, and authenticate the wireless device based on the acknowledgement signature. In some cases, AP ACK authorization manager 1315 may compute a stored acknowledgment signature (e.g., based on the soliciting frame). The AP ACK authorization manager 1315 may then compare the stored acknowledgment signature with the identified acknowledgment signature and determine that the received frame is from the wireless device if the stored acknowledgement signature is equal to the received acknowledgement signature. In another aspect, AP ACK authorization manager 1315 may decrypt the received acknowledgement signature based on the encryption key and determine if the decrypted value matches the value from the soliciting frame (e.g., the stored acknowledgement signature). If so, then the wireless device 1305 may determine that the ACK frame was received from the intended wireless device; otherwise, in some cases, wireless device 1305 may ignore the ACK frame.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1635 described with reference to FIG. 16. The transmitter 1320 may include a single antenna, or it may include a set of antennas.

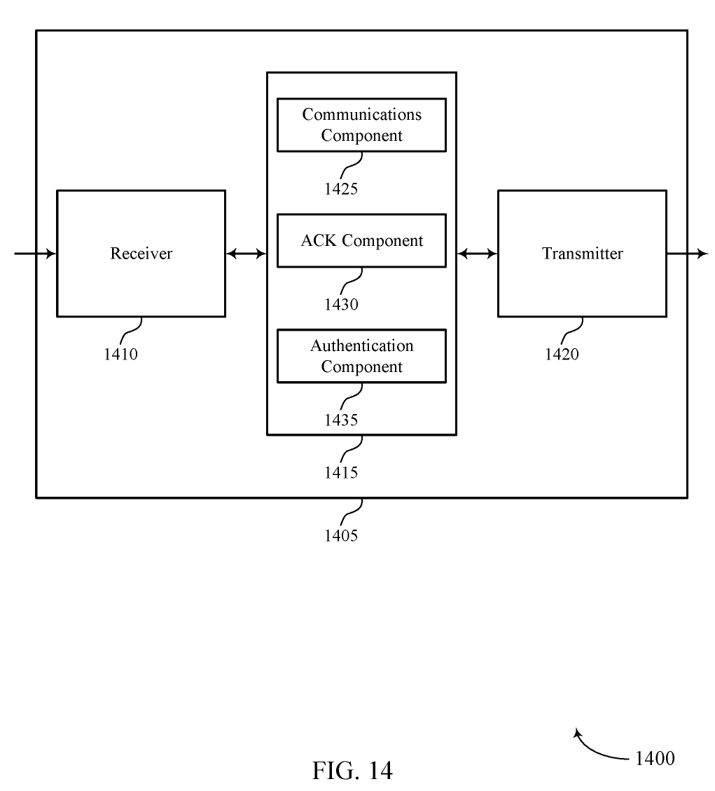

FIG. 14 shows a block diagram 1400 of a wireless device 1405 that supports adding authenticatable signatures such as acknowledgment signatures to ACKs in accordance with various aspects of the present disclosure. Wireless device 1405 may be an example of aspects of a wireless device 1305 or an AP 105 as described with reference to FIGS. 1 and 13. Wireless device 1405 may include receiver 1410, AP ACK authorization manager 1415, and transmitter 1420. Wireless device 1405 may also include a processor. Each of these components may be in communication with one another (e.g., via one or more buses).

Receiver 1410 may receive information such as packets, user data, or control information associated with various information channels (e.g., control channels, data channels, and information related to adding authenticatable signatures to ACKs, etc.). Information may be passed on to other components of the device. The receiver 1410 may be an example of aspects of the transceiver 1635 described with reference to FIG. 16.

AP ACK authorization manager 1415 may be an example of aspects of the AP ACK authorization manager 1615 described with reference to FIG. 16. AP ACK authorization manager 1415 may also include communications component 1425, ACK component 1430, and authentication component 1435.

Communications component 1425 may transmit a communication to a wireless device and receive a frame including an acknowledgement for the communication from the wireless device. In some cases, the information from the transmitted communication includes a CRC.

ACK component 1430 may identify an acknowledgement signature from content of the frame, the acknowledgement signature being based on a key shared with the wireless device. In some cases, identifying the acknowledgement signature includes: identifying the acknowledgement signature from a frame control portion of the frame. In some cases, identifying the acknowledgement signature includes: identifying the acknowledgement signature from a duration field of the frame. In some cases, a MSB of the duration field is one. In some cases, identifying the acknowledgement signature includes: identifying the acknowledgement signature from an address field of the frame. In some cases, identifying the acknowledgement signature includes: identifying the acknowledgement signature from a CRC of the frame. In some cases, identifying the acknowledgement signature includes: identifying the acknowledgement signature from a MIC of the frame. In some cases, the acknowledgement includes a block acknowledgement.

Authentication component 1435 may authenticate the wireless device based on the acknowledgement signature. In some cases, identifying the acknowledgement signature includes: identifying a unique signature of the wireless device based on information from the transmitted communication, the key shared with the wireless device, and a hash function.

Transmitter 1420 may transmit signals generated by other components of the device. In some examples, the transmitter 1420 may be collocated with a receiver 1410 in a transceiver module. For example, the transmitter 1420 may be an example of aspects of the transceiver 1635 described with reference to FIG. 16. The transmitter 1420 may include a single antenna, or it may include a set of antennas.

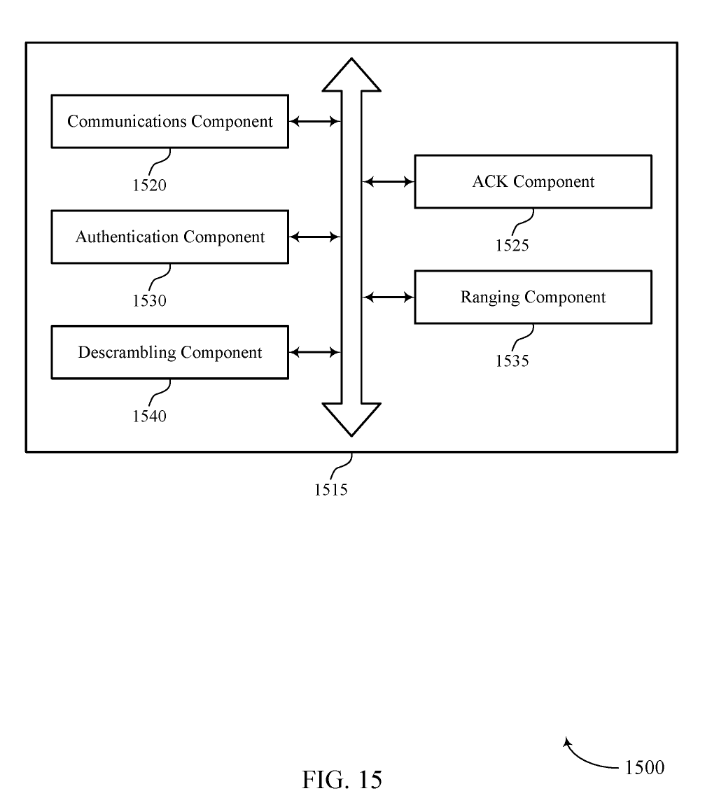

FIG. 15 shows a block diagram 1500 of an AP ACK authorization manager 1515 that supports adding authenticatable signatures such as acknowledgment signatures to ACKs in accordance with various aspects of the present disclosure. The AP ACK authorization manager 1515 may be an example of aspects of an AP ACK authorization manager 1615 described with reference to FIGS. 13, 14, and 16. The AP ACK authorization manager 1515 may include communications component 1520, ACK component 1525, authentication component 1530, ranging component 1535, and descrambling component 1540. Each of these modules may communicate, directly or indirectly, with one another (e.g., via one or more buses).

Communications component 1520 may transmit a communication to a wireless device and receive a frame including an acknowledgement for the communication from the wireless device. In some cases, the information from the transmitted communication includes a CRC.

ACK component 1525 may identify an acknowledgement signature from content of the frame, the acknowledgement signature being based on a key shared with the wireless device. In some cases, identifying the acknowledgement signature includes: identifying the acknowledgement signature from a frame control portion of the frame. In some cases, identifying the acknowledgement signature includes: identifying the acknowledgement signature from a duration field of the frame. In some cases, a MSB of the duration field is one. In some cases, identifying the acknowledgement signature includes: identifying the acknowledgement signature from an address field of the frame. In some cases, identifying the acknowledgement signature includes: identifying the acknowledgement signature from a CRC of the frame. In some cases, identifying the acknowledgement signature includes: identifying the acknowledgement signature from a MIC of the frame. In some cases, the acknowledgement includes a block acknowledgement.

Authentication component 1530 may authenticate the wireless device based on the acknowledgement signature. In some cases, identifying the acknowledgement signature includes: identifying a unique signature of the wireless device based on information from the transmitted communication, the key shared with the wireless device, and a hash function.

Ranging component 1535 may determine a ranging estimate to the wireless device based on the acknowledgement. Descrambling component 1540 may use a seed to descramble scrambled information. In some cases, identifying the acknowledgement signature includes: descrambling the frame using a scrambler seed which is based on the acknowledgement signature.

FIG. 16 shows a diagram of a system 1600 including a device 1605 that supports adding authenticatable signatures such as acknowledgment signatures to ACKs in accordance with various aspects of the present disclosure. Device 1605 may be an example of or include the components of AP 105 as described above, e.g., with reference to FIG. 1. Device 1605 may include components for bi-directional voice and data communications including components for transmitting and receiving communications, including AP ACK authorization manager 1615, processor 1620, memory 1625, software 1630, transceiver 1635, antenna 1640, and I/O controller 1645. These components may be in electronic communication via one or more busses (e.g., bus 1610).

Processor 1620 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1620 may be configured to operate a memory array using a memory controller. In other cases, a memory controller may be integrated into processor 1620. Processor 1620 may be configured to execute computer-readable instructions stored in a memory to perform various functions (e.g., functions or tasks supporting adding authenticatable signatures to ACKs) 1620.

Memory 1625 may include RAM and ROM. The memory 1625 may store computer-readable, computer-executable software 1630 including instructions that, when executed, cause the processor to perform various functions described herein. In some cases, the memory 1625 may contain, among other things, a BIOS which may control basic hardware and/or software operation such as the interaction with peripheral components or devices.

Software 1630 may include code to implement aspects of the present disclosure, including code to support adding authenticatable signatures to ACKs. Software 1630 may be stored in a non-transitory computer-readable medium such as system memory or other memory. In some cases, the software 1630 may not be directly executable by the processor but may cause a computer (e.g., when compiled and executed) to perform functions described herein.

Transceiver 1635 may communicate bi-directionally, via one or more antennas, wired, or wireless links as described above. For example, the transceiver 1635 may represent a wireless transceiver and may communicate bi-directionally with another wireless transceiver. The transceiver 1635 may also include a modem to modulate the packets and provide the modulated packets to the antennas for transmission, and to demodulate packets received from the antennas.

In some cases, the wireless device may include a single antenna 1640. However, in some cases the device may have more than one antenna 1640, which may be capable of concurrently transmitting or receiving multiple wireless transmissions.

I/O controller 1645 may manage input and output signals for device 1605. I/O controller 1645 may also manage peripherals not integrated into device 1605. In some cases, I/O controller 1645 may represent a physical connection or port to an external peripheral. In some cases, I/O controller 1645 may utilize an operating system such as iOS®, ANDROID®, MS-DOS®, MS-WINDOWS®, OS/2®, UNIX®, LINUX®, or another known operating system.

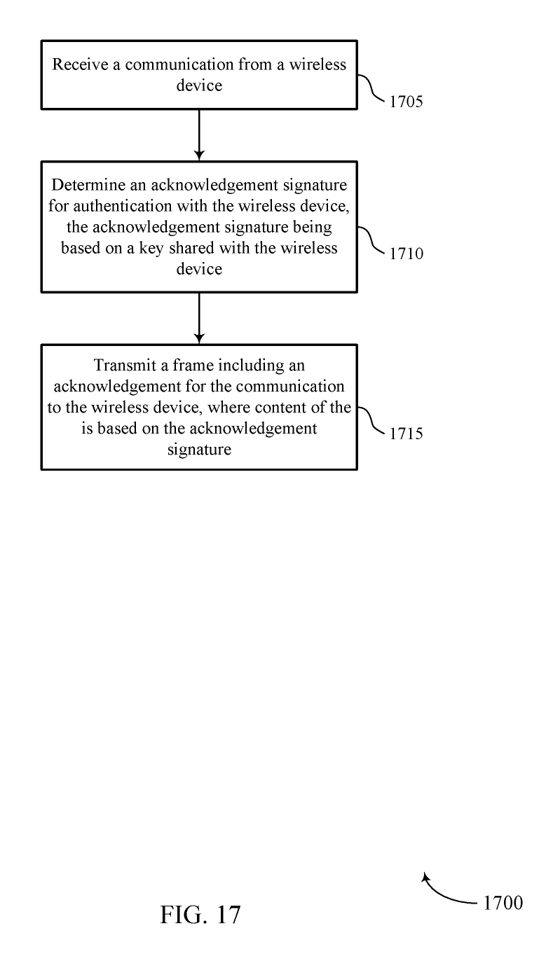

FIG. 17 shows a flowchart illustrating a method 1700 for adding authenticatable signatures such as acknowledgment signatures to ACKs in accordance with various aspects of the present disclosure. The operations of method 1700 may be implemented by a STA 115 or its components as described herein. For example, the operations of method 1700 may be performed by a STA ACK authorization manager as described with reference to FIGS. 9 through 12. In some examples, a STA 115 may execute a set of codes to control the functional elements of the device to perform the functions described below. Additionally or alternatively, the STA 115 may perform aspects of the functions described below using special-purpose hardware.

At block 1705 the STA 115 may receive a communication from a wireless device. The operations of block 1705 may be performed according to the methods described with reference to FIGS. 1 through 8. In certain examples, aspects of the operations of block 1705 may be performed by a communications component as described with reference to FIGS. 9 through 12.

At block 1710 the STA 115 may determine an acknowledgement signature for authentication with the wireless device, the acknowledgement signature being based at least in part on a key shared with the wireless device. The operations of block 1710 may be performed according to the methods described with reference to FIGS. 1 through 8. In certain examples, aspects of the operations of block 1710 may be performed by an ACK signature component as described with reference to FIGS. 9 through 12.

At block 1715 the STA 115 may transmit a frame comprising an acknowledgement for the communication to the wireless device, wherein content of the frame is based at least in part on the acknowledgement signature. The operations of block 1715 may be performed according to the methods described with reference to FIGS. 1 through 8. In certain examples, aspects of the operations of block 1715 may be performed by an ACK component as described with reference to FIGS. 9 through 12.

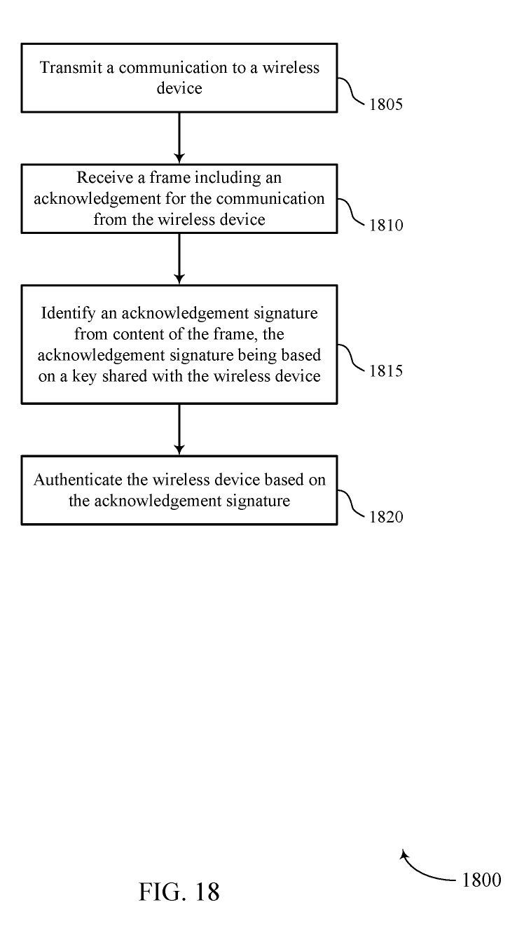

FIG. 18 shows a flowchart illustrating a method 1800 for adding authenticatable signatures such as acknowledgment signatures to ACKs in accordance with various aspects of the present disclosure. The operations of method 1800 may be implemented by an AP 105 or its components as described herein. For example, the operations of method 1800 may be performed by an AP ACK authorization manager as described with reference to FIGS. 13 through 16. In some examples, an AP 105 may execute a set of codes to control the functional elements of the device to perform the functions described below. Additionally or alternatively, the AP 105 may perform aspects of the functions described below using special-purpose hardware.

At block 1805 the AP 105 may transmit a communication to a wireless device. The operations of block 1805 may be performed according to the methods described with reference to FIGS. 1 through 8. In certain examples, aspects of the operations of block 1805 may be performed by a communications component as described with reference to FIGS. 13 through 16.

At block 1810 the AP 105 may receive a frame comprising an acknowledgement for the communication from the wireless device. The operations of block 1810 may be performed according to the methods described with reference to FIGS. 1 through 8. In certain examples, aspects of the operations of block 1810 may be performed by a communications component as described with reference to FIGS. 13 through 16.

At block 1815 the AP 105 may identify an acknowledgement signature from content of the frame, the acknowledgement signature being based at least in part on a key shared with the wireless device. The operations of block 1815 may be performed according to the methods described with reference to FIGS. 1 through 8. In certain examples, aspects of the operations of block 1815 may be performed by an ACK component as described with reference to FIGS. 13 through 16.

At block 1820 the AP 105 may authenticate the wireless device based at least in part on the acknowledgement signature. The operations of block 1820 may be performed according to the methods described with reference to FIGS. 1 through 8. In certain examples, aspects of the operations of block 1820 may be performed by an authentication component as described with reference to FIGS. 13 through 16.

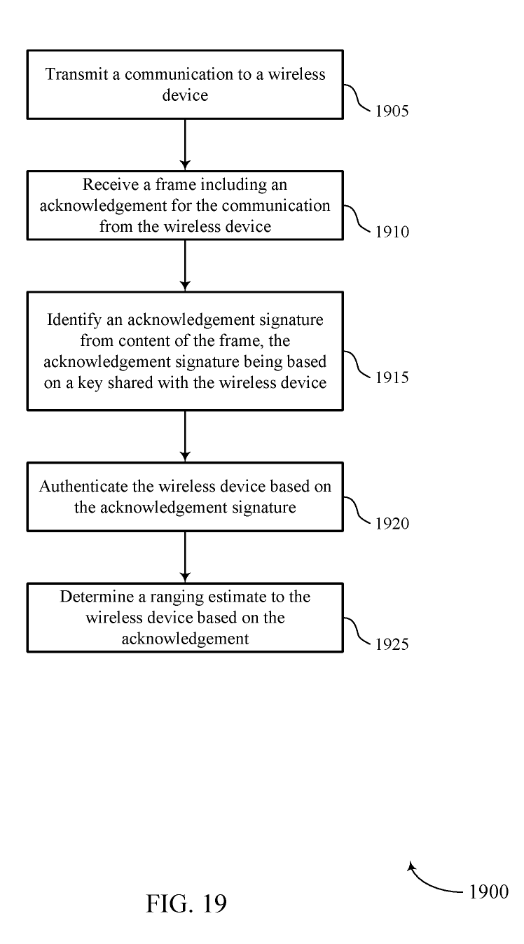

FIG. 19 shows a flowchart illustrating a method 1900 for adding authenticatable signatures such as acknowledgment signatures to ACKs in accordance with various aspects of the present disclosure. The operations of method 1900 may be implemented by an AP 105 or its components as described herein. For example, the operations of method 1900 may be performed by an AP ACK authorization manager as described with reference to FIGS. 13 through 16. In some examples, an AP 105 may execute a set of codes to control the functional elements of the device to perform the functions described below. Additionally or alternatively, the AP 105 may perform aspects of the functions described below using special-purpose hardware.

At block 1905 the AP 105 may transmit a communication to a wireless device. The operations of block 1905 may be performed according to the methods described with reference to FIGS. 1 through 8. In certain examples, aspects of the operations of block 1905 may be performed by a communications component as described with reference to FIGS. 13 through 16.

At block 1910 the AP 105 may receive a frame comprising an acknowledgement for the communication from the wireless device. The operations of block 1910 may be performed according to the methods described with reference to FIGS. 1 through 8. In certain examples, aspects of the operations of block 1910 may be performed by a communications component as described with reference to FIGS. 13 through 16.

At block 1915 the AP 105 may identify an acknowledgement signature from content of the frame, the acknowledgement signature being based at least in part on a key shared with the wireless device. The operations of block 1915 may be performed according to the methods described with reference to FIGS. 1 through 8. In certain examples, aspects of the operations of block 1915 may be performed by an ACK component as described with reference to FIGS. 13 through 16.

At block 1920 the AP 105 may authenticate the wireless device based at least in part on the acknowledgement signature. The operations of block 1920 may be performed according to the methods described with reference to FIGS. 1 through 8. In certain examples, aspects of the operations of block 1920 may be performed by an authentication component as described with reference to FIGS. 13 through 16.

At block 1925 the AP 105 may determine a ranging estimate to the wireless device based at least in part on the acknowledgement. The operations of block 1925 may be performed according to the methods described with reference to FIGS. 1 through 8. In certain examples, aspects of the operations of block 1925 may be performed by a ranging component as described with reference to FIGS. 13 through 16.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a communication from a wireless device;
determining an acknowledgement signature for authentication with the wireless device, the acknowledgement signature being based at least in part on a key shared with the wireless device; and
transmitting a frame comprising an acknowledgement for the communication to the wireless device, wherein content of the frame is based at least in part on the acknowledgement signature.

2. The method of claim 1, further comprising:
determining that the acknowledgement is to be used by the wireless device for range finding; and
including the acknowledgement signature in the frame based at least in part on the determination.

3. The method of claim 1, wherein determining the acknowledgement signature comprises:
determining a unique signature based at least in part on information from the received communication, the key shared with the wireless device, and a hash function.

4. The method of claim 3, wherein the information from the received communication includes a cyclic redundancy check (CRC).

5. The method of claim 1, further comprising:
determining a scrambler seed based at least in part on the acknowledgement signature; and
applying the scrambler seed to the frame.

6. The method of claim 1, further comprising:
including the acknowledgement signature in a scrambler seed field of the frame, a frame control portion of the frame, a duration field of the frame, an address field of the frame, or a cyclic redundancy check (CRC) field of the frame.

7. The method of claim 6, wherein the acknowledgement signature is provided via seven bits of the scrambler seed field.

8. The method of claim 6, wherein the frame control portion of the frame includes sixteen bits, and wherein the acknowledgement signature is provided via the least significant eight bits of the sixteen bits of a frame control field.

9. The method of claim 6, further comprising:
setting a most significant bit (MSB) of the duration field to one.

10. The method of claim 9, further comprising:
setting the MSB of the duration field to one indicates that the duration field includes the acknowledgment signature, and wherein the acknowledgment signature is provided via at least one or more of a remaining set of bits of the duration field.

11. The method of claim 6, wherein the address field of the frame comprises a receive address field.

12. The method of claim 1, further comprising:
determining a cyclic redundancy check (CRC) for the acknowledgement based at least in part on the acknowledgement signature; and
including the CRC in the frame.

13. The method of claim 1, wherein transmitting the frame comprising the acknowledgement further comprises:
concatenating the acknowledgment signature with at least one of a scrambler seed field, a frame control field, a duration field, or a receive address field;
calculating cyclic redundancy check (CRC) information based on the concatenation; and
inserting the CRC information into a CRC field.

14. The method of claim 1, further comprising:
including an encryption header within the frame; and
determining a message integrity check (MIC) for the acknowledgement based at least in part on the encryption header, wherein the MIC is the acknowledgement signature.

15. The method of claim 1, wherein the acknowledgement comprises a block acknowledgement.

16. The method of claim 15, further comprising:
including an encryption header, a block acknowledgement control field and a block acknowledgement information field within the frame; and
determining a message integrity check (MIC) for the acknowledgement based at least in part on the encryption header without encrypting the block acknowledgement control field and the block acknowledgement information field, wherein the MIC is the acknowledgement signature.

17. The method of claim 1, further comprising:
including a control wrapper in the frame such that the acknowledgement is wrapped between an encryption header and a message integrity check (MIC), wherein the MIC is the acknowledgement signature.

18. The method of claim 1, wherein the acknowledgement signature is determined based at least in part on a timing synchronization function associated with the frame, a sequence number included in the frame, or one or more fields in the frame.

19. The method of claim 1, wherein the frame is a fine timing measurement (FTM) response or a first FTM frame.

20. A method for wireless communication, comprising:
transmitting a communication to a wireless device;
receiving a frame comprising an acknowledgement for the communication from the wireless device;
identifying an acknowledgement signature from content of the frame, the acknowledgement signature being based at least in part on a key shared with the wireless device; and
authenticating the wireless device based at least in part on the acknowledgement signature.

21. The method of claim 20, further comprising:
determining a ranging estimate to the wireless device based at least in part on the acknowledgement.

22. The method of claim 20, wherein identifying the acknowledgement signature comprises:
identifying a unique signature of the wireless device based at least in part on information from the transmitted communication, the key shared with the wireless device, and a hash function.

23. The method of claim 22, wherein identifying the unique signature of the wireless device further comprises:
computing a stored acknowledgment signature based on a frame and the key shared with the wireless device;
comparing the stored acknowledgment signature with the received acknowledgement signature; and
determining that the received frame is from the wireless device if the stored acknowledgement signature is equal to the received acknowledgement signature.

24. The method of claim 22, wherein the information from the transmitted communication includes a cyclic redundancy check (CRC).

25. The method of claim 20, wherein identifying the acknowledgement signature comprises:
descrambling the frame using a scrambler seed which is based at least in part on the acknowledgement signature.

26. The method of claim 20, wherein identifying the acknowledgement signature comprises:
identifying the acknowledgement signature from a frame control portion of the frame, a duration field of the frame, an address field of the frame, a cyclic redundancy check (CRC) of the frame, or a message integrity check (MIC) of the frame.

27. The method of claim 20, wherein the acknowledgement signature is determined based at least in part on a timing synchronization function associated with the frame, a sequence number included in the frame, or one or more fields in the frame.

28. The method of claim 20, wherein the frame is a fine timing measurement (FTM) response or a first FTM frame.

29. An apparatus for wireless communication, comprising:
a processor;
memory in electronic communication with the processor; and
instructions stored in the memory and operable, when executed by the processor, to cause the apparatus to:
receive a communication from a wireless device;
determine an acknowledgement signature for authentication with the wireless device, the acknowledgement signature being based at least in part on a key shared with the wireless device; and
transmit a frame comprising an acknowledgement for the communication to the wireless device, wherein content of the frame is based at least in part on the acknowledgement signature.

30. An apparatus for wireless communication, comprising:
a processor;
memory in electronic communication with the processor; and
instructions stored in the memory and operable, when executed by the processor, to cause the apparatus to:
transmit a communication to a wireless device;
receive a frame comprising an acknowledgement for the communication from the wireless device;
identify an acknowledgement signature from content of the frame, the acknowledgement signature being based at least in part on a key shared with the wireless device; and
authenticate the wireless device based at least in part on the acknowledgement signature.
